(19) United States
(12) Patent Application Publication
(10) Pub. No.: US 2012/0201745 A1
(43) Pub. Date: Aug. 9, 2012

(54) HYDROGEN PRODUCTION FOR LOW TEMPERATURE FUEL CELLS FROM THE STEAM REFORMING AND OXIDATIVE REFORMING OF ALCOHOLS USING CATALYSTS BASED ON MIXED OXIDES WITH PEROVSKITE STRUCTURE

(76) Inventors: Fabio Bellot Noronha, Icarai-Niteroi (BR); Lisiane Veiga Mattos, Icarai-Niteroi (BR); Sania Maria Lima, Leme (BR); Adriana Maria Da Silva, Leme (BR); Jose Mansur Assaf, Sao Carlos/SP (BR)

(21) Appl. No.: 13/501,614

(22) PCT Filed: Aug. 11, 2010
(86) PCT No.: PCT/BR2010/000328

§ 371 Date: Apr. 12, 2012

(30) Foreign Application Priority Data
Oct. 14, 2009 (BR) PI0905970-9

(51) Int. Cl. C01B 3/22; B01J 23/10

(52) U.S. Cl. 423/648.1; 502/303

(57) ABSTRACT

The present invention comprises the use of mixed oxide based catalysts containing at least lanthanum, nickel and oxygen in the reactions of steam reforming and oxidative reforming of alcohols at low temperature or a mixture of alcohols, such as bio-ethanol. The catalysts have a perovskite structure represented by Lai₁₋ₓMₓNIO₃, where x from 0.0 to 1.0 and M=elements of the group of alkaline earth metals or lanthanides. Hydrogen generated in the method of the invention can be used, among other applications, in a low temperature fuel cell as the PEM type.

### CROSS REFERENCE TO RELATED APPLICATION

This application is a national stage entry of PCT/BR2010/000328 filed Aug. 11, 2010, under the International Convention, claiming priority over Brazilian patent application No. BR P109005970-9 filed Oct. 14, 2009.

### FIELD OF THE INVENTION

The present invention is the use of mixed oxide based catalysts containing at least lanthanum, nickel and oxygen in the reactions of steam reforming and oxidative reforming of alcohols at low temperature, in particular ethanol, or a mixture of alcohols such as for example, bio-ethanol.

These materials showed high activity and stability with high selectivity for hydrogen in the reactions mentioned above.

### BACKGROUND OF THE INVENTION

Currently, there is a strong interest in using hydrogen as an alternative source of energy produced by fuel cells. The use of hydrogen would reduce the world dependence on fossil fuels and could contribute to reducing emissions of greenhouse gases (CH₄ and CO₂) and air pollution (CO and NO_{R}).

Fuel cells are devices for the generation of innovative energy. These systems convert the chemical energy of a reaction directly into electrical energy and have a much higher efficiency than conventional combustion engines [Amphletts et al. J. Int Hydrogen Energy 19 (1994) 131; Hirschenhofer et al., Fuel Cell Handbook, 1998] and are relatively compact.

There are several types of fuel cells, which are classified according to the electrolyte used and the reaction temperature. The cell-based proton exchange membrane (PEM cells) operate at low temperatures (˜100C) and provide high energy density with fast response to load variations [Hirschenhofer et al., Fuel Cell Handbook, 1998].

Various fuels such as gasoline, diesel, LPG, methane and alcohols, especially ethanol, can be used as sources of hydrogen for fuel cells. The bio-ethanol, for example, obtained from biomass has been considered a promising source of renewable hydrogen for these systems, since, in addition to reducing the greenhouse effect, has lower toxicity than conventional fuels. Another advantage in the use of bio-ethanol, in the case of Brazil, is the existence of a well established infrastructure for their production and distribution. However, the use of this fuel has some disadvantages such as the formation of byproducts and catalyst deactivation [Guil et al., Phys. Chem. B 109 (2005) 10813; Takezawa & Iwasa, Catal. Today 36 (1997) 45; Cavallaro, Mondello & Freni, J. Power Sources 102 (2001) 198]. Another problem related to the use of bio-ethanol are the high costs associated with its separation of the aqueous solution (distillation processes) obtained after fermentation of biomass, which contains about 10 wt % ethane by volume of solution (ratio molar H2O/ethanol=23) [Vargas et al. Catal. Today 107 (2005) 417]. Thus, the development of catalysts that show good performance under a load containing high ratios H2O/ethanol eliminate the need for use of distillation processes, reducing costs of using ethanol as a source of hydrogen for fuel cells.

Hydrogen can be obtained from alcohols by steam reforming [J. C. Vargas, S. Libs, A. Roger, A. Kiennemann, Catal. Today 107 (2005) 417, N. Takezawa, N. Iwasa, Catal. Today 36 (1997) 45; S. Cavallaro, N. Mondello, S. Freni, J. Power Sources 102 (2001) 198; F. j. Marino, E. g. Cerrela, S. Duhalde, M. Jobbagy, M. A. Laborde, Int J. Hydrogen Energy 12 (1998) 1095; F. j. Marino, M. Boveri, G. Baronetti, M. Laborde, Int. J. Hydrogen Energy 26 (2001) 665; E. Y. Garcia, M. a Laborde, Int. J. Hydrogen Energy 16 (1991) 307; S. Freni, N. Mondello, S. Cavallaro, G. Cacciola, V. N. Parmon, V. A. Sobyanin, React. Kinet. Catal. Lett. 71, (2000) 143; V. V. Galvita, G. L. Semin, V. D. Belyaev, V. A. Semikolenov, P. Tsiakaras, Sobyanin, Appl. Catal., A 220 (2001) 123; A. N. Fatsikostas, D. I. Kondarides, X. E. Verykios, Chem. Commun. 851 (2001); A. N Fatsikostas, D. I. Kondarides, X. E. Verykios, Catal. Today 75 (2002) 145; J. P. Breen, R. Burch, H. M. Coleman, Appl. Catal., B. 39 (2002) 65; J. Llorca, N. Homs, J. Sales, P. R. de la Piscina, J. Catal. 209 (2002) 306; J. Comas, F. Marino, M. Laborde, N. Amadeo, Chem. Eng. J. 98 (2004) 61; H. V. Fajardo, L. F. D. Probst, Appl. Catal., A 306 (2006) 134; e. c. Wanat, K. Venkataraman, L. D. Schmidt, Appl. Catal., A 276 (2004) 155; F. Frusteri, S. Freni, V. Chiodo, L. Spadaro, O. Di Blasi, G. Bonura, S. Cavallaro, Appl. Catal., A 270 (2004) 1] and of oxidative reform [Vessellia et al., Appl. Catal., A 281 (2005) 13922-26; Navarro et al., Appl. Catal., B 55 (2005) 229; Velu et al., Catal. Lett. 82 (2002) 145; Kugai, Velu & Song, Catal Lett. 101 (2005) 255; Deluga et al., Science 303 (2004) 13].

The steam reforming of alcohols, for example, ethanol (equation 1) is an endodermal reaction, which makes it necessary the addition of energy to the system by increasing the costs of the process [A. Haryanto, S. Fernando, N. Murali, S. Adhikari, Energy & Fuels 19 (2005) 2098]. One alternative to solve this problem would be to add air or oxygen to the feed stream in order to obtain the thermal neutrality of the reaction [D K Ligurians, K. Goundani, X. E. Verykios, J. Int Hydrogen Energy 29 (2004) 419]. This process is called oxidative reforming of alcohols. Equation 2 represents the oxidative reforming of ethanol. [D. K. Ligurians, K. Goundani, X. E. Verykios, J. Int Hydrogen Energy 29 (2004) 419].

C₂H₅OH+3H₂O→2CO₂+6H₂ (ΔH° 298=+347,4 kJ/mol) (1)

C₂H₅OH+0,61O₂+1,78 H₂O→2CO₂+4,78H₂ (ΔH° 298=0 kJ/mol) (2)

However, in the two routes may occur several parallel reactions, depending on the catalyst and reaction conditions used. In particular, for ethanol, may be mentioned the following reactions:

dehydration of ethanol to ethylene (equation 3) [A. Haryanto, S. Fernando, N. Murali, S. Adhikari, Energy & Fuels 19 (2005) 2098].

C₂H₅OH→C₂H₄+H₂O (3)

(ii) decomposition of ethanol (equation 4), forming methane, carbon monoxide and hydrogen. The methane, in turn, can react with water (equation 5), producing carbon monoxide and hydrogen (steam reforming of methane) [A. Haryanto, S. Fernando, N. Murali, S. Adhikari, Energy & Fuels 19 (2005) 2098].

C₂H₅OH→CH₄+CO+H₂ (4)

CH₄+H₂O→CO+3H₂ (5)

(iii) dehydrogenation of ethanol to form acetaldehyde (Equation 6) [A. Haryanto, S. Fernando, N. Murali, S. Adhikari, Energy & Fuels 19 (2005) 2098].

C₂H₅OH→C₂H₄O+H₂ (6)

(iv) Formation of acetone (Equation 7) [T. Nishiguchi, T. Matsumoto, H. Kanai, K. Utan, Y. Matsumurab, W-J Shenc, S. Imamura, Appl. Catal., A 279 (2005) 273].

2C₂H₅OH+H₂O→CH₃COCH₃+CO₂+4H₂ (7)

As shown in the above equations, the occurrence of side reactions leads to the formation of byproducts such as methane, acetaldehyde, acetone and ethylene, which contribute to the decrease in hydrogen yield. In addition, some of these compounds are precursors to the formation of carbon deposits that cause catalyst deactivation.

Thus, the appropriate catalyst for the reform processes of alcohols should maximize hydrogen production and minimize the formation of byproducts. Most of the patents [US 2005/0244329; FR 2 857 003-A1; US 2003/0022950 A1; US 2001/0023034 A1; U.S. Pat. No. 6.387.554 B1; FR 2 795 339-A1; WO 99/61368; US 2005/0260123 A1; EP 1314 688 B1 898.686; US 2004/0137288 A1] and works [N. Takezawa, N. Iwasa, Catal. Today 36 (1997) 45; S. Cavallaro, N. Mondello, S. Freni, J. Power Sources 102 (2001) 198; J. C. Vargas, S. Libs, A. Roger, A. Kiennemann, Catal. Today 107 (2005) 417; F. J. Marino, E. G. Cerrela, S. Duhalde, M. Jobbagy, M. A. Laborde, Int. J. Hydrogen Energy 12 (1998) 1095 F. J. Marino, M. Boveri, G. Baronetti, M. Laborde, Int J. Hydrogen Energy 26 (2001) 665; E. Y. Garcia, M. A. Laborde, Int. J. Hydrogen Energy 16 (1991) 307; S. Freni, N. Mondello, S. Cavallaro, G. Cacciola, V. N. Parmon, V. A. Sobyanin, React. Kinet. Catal. Lett. 71, (2000) 143; V. V. Galvita, G. L. Semin, V. D. Belyaev, V. A. Semikolenov, P. Tsiakaras, Sobyanin, Appl. Catal., A 220 (2001) 123; A. N. Fatsikostas, D. I. Kondarides, X. E. Verykios, Chem. Commun. 851 (2001); A. N. Fatsikostas, D. I. Kondarides, X. E. Verykios, Catal. Today 75 (2002) 145; J. P. Breen, R. Burch, H. M. Coleman, Appl. Catal., B. 39 (2002) 65; J. Llorca, N. Homs, J. Sales, P. R. de la Piscina, J. Catal. 209 (2002) 306; J. Comas, F. Mariño, M. Laborde, N. Amadeo, Chem. Eng. J. 98 (2004) 61; H. V. Fajardo, L. F. D. Probst, Appl. Catal., A 306 (2006) 134; E. C. Wanat, K. Venkataraman, L. D. Schmidt, Appl. Catal., A 276 (2004) 155; F. Frusteri, S. Freni, V. Chiodo, L. Spadaro, O. Di Blasi, G. Bonura, S. Cavallaro, Appl. Catal., A 270 (2004) 1; E. Vesselia, G. Comellia, R. Roseia, S. Frenic, F. Frusteric, S. Cavallaro, Appl. Catal., A 281 (2005) 139; R. M. Navarro, M. C. Alvarez-Galvana, M. C. Sanchez-Sanchez, F. Rosab, J. L. G. Fierro, Appl. Catal., B 55 (2005) 229; s. Velu, N. Satoh, C. S. Gopinath, K. Suzuki, Catal. Lett. 82 (2002) 145; J. Kugai, S. Velu, C. Song, Catal. Lett. 101 (2005) 255; G. A. Deluga, J. R. Salge, L. D. Schmidt, X. E. Verykios, Science 303 (2004 13] found in the literature uses metals (noble metals, Cu, Co and Ni) supported on different oxides (Al₂O₃, La₂O₃, MgO, SiO₂, TiO₂, CeO₂, ZrO₂) catalysts for steam reforming and oxidative reforming of alcohols. Most of these catalysts only in the best performance temperatures high (between 873 and 1023 K). At low temperatures, the formation of oxygenated products increases and the ance production is thermodynamically favored, leading to catalyst deactivation. On the other hand, at elevated temperatures, the thermodynamic ance favors the formation of CO in quantities above that tolerated by PEM cells (˜10 ppm). So one of the most important aspects of the process of producing hydrogen for fuel cells is the development of an active catalyst, highly selective and stable to lower reaction temperatures.

Some works [K. Urasaki, K. Tokunaga, Y. Sekine, M. Matsukata, E. Kikuchi, Catal. Commun. 9 (2008) 600; F. Romero-Sarria, J. C. Vargas, A. Roger, A. Kiennemann, Catal. Today 133 (2008) 149] showed that a strong interaction between the active phase and support with a high mobility of oxygen prevents the formation of carbon deposits, leading to an increased stability of supported metal catalysts in steam reforming of alcohols in particular, ethanol. Thus, some authors have proposed the use of mixed oxides as catalysts in steam reforming and oxidative reforming of alcohols {V But G. Baronetti, N. Amadeo, M. Laborde, Chem. Mr. J. 138 (2008) 602; V. Mas M. L. Dieuzide, M. Jobbagy, G. Baronetti, N. Amadeo, M. Laborde, Catal. Today 133 (2008) 1201; S. Velu, K. Suzuki, M. Vijayaraj, S. Barman, S. C. Gopinath, Appl. Catal., B 55 (2005) 287]. According to these authors, as the active phase is embedded in the structure of the mixed oxide, it would be possible to obtain a strong active phase-support interaction, preventing the loss of catalytic activity. However, a careful evaluation of the results shows that in most cases, the mixed oxides studied still have a significant loss of catalytic activity and the formation of byproducts such as ethylene, acetaldehyde and acetone.

The behavior of the mixed oxide Ce—Zr—Co as a catalyst for reforming of ethanol was evaluated at 713 K [J C Vargas, S. Libs, A. Roger, A. Kiennemann, Catal. Today 107 (2005) 417]. We used two different supply chains. One was composed of a real solution of ethanol (molar ratio ethanol: H₂O=1,0:5,95) and the other contained a mixture of water and ethanol (molar ratio ethanol: H₂O=1,0:6,0). For the two streams of power used, the initial conversion was 100%. However, after 25 hours of reaction, the conversion fell significantly in both cases, reaching a value around 53% for bio-ethanol, and 44% for the mixture of water/ethanol. The loss of catalytic activity was accompanied by a sharp fall in yields of H₂ and increased a significant formation of ethylene, acetone and acetaldehyde.

Galetti et al. [A. E. Galetti, M. F. Gomez, L A Arrue, A J Marchi, M C Abello, Catal. Commun. 9 (2008) 1201] evaluated the performance of mixed oxides CuCoZnAl in steam reforming of ethanol at 673, 773 and 873 K, using a molar ratio of 3.8 H₂O/ethanol. At 673 K, the conversion of ethanol decreased from 100% to 35% after 5 hours of reaction. The hydrogen yield also suffered a sharp decline and the main products detected were CO₂, acetaldehyde and acetone. In addition, we observed an increase in pressure in the catalyst bed. When the reaction temperature was increased to 773 K, the initial conversion was also 100%. However, after 3 hours, the reaction had to be stopped because it occurred during a total blockade of the catalyst bed. The only products observed were H₂, CO, CO₂ and methane. The characterization of the catalyst after the reaction showed the formation of a large amount of ance at both temperatures. The catalyst showed complete conversion of ethanol, high stability and good performance for hydrogen only at 873 K. However, we observed the formation of a large amount of CO and CO₂.

Some authors [V. Mas G. Baronetti, N. Amadeo, M. Laborde, Chem. Mr. J. 138 (2008) 602; V. Mas M. L. Dieuzide, M. Jobbagy, G. Baronetti, N. Amadeo, M. Laborde, Catal. Today 133 (2008) 319; S. Velu, K. Suzuki, M. Vijayaraj, S. Barman, C S Gopinath, Appl., B 55 (2005) 287] studied the behavior of mixed oxides Cu₁₋ₓNiₓAl and NiAl in reforming reactions of ethanol, obtained from hydrotalcite CuNiZnAl and Ni(II)-Al(III) respectively. According to these authors, the use of hydrotalcite as precursors leads to obtain mixed oxides with high surface area, high thermal stability and form of the metal particles well dispersed after the reduction treatment. In the case of Cu₁₋ₓNiₓZnAl mixed oxides (x=0.0 to 1.0) [S. Velu, K. Suzuki, M. Vijayaraj, S. Barman, S. C. Gopinath, Appl. Catal., B 55 (2005) 287], it was performed the reaction of oxidative reforming of ethanol between 473 and 573 K, using a H₂O/ethanol ratio equal to 3.0 and a ratio equal to 0.4 O₂/ethanol. The addition of Ni to the system did not influence the conversion of ethanol, which remained around 90% (to 573 K) for all catalysts studied. The selectivity to hydrogen was also unaffected by the composition of the mixed oxide and remained around 50 to 55%. In addition, we observed a significant production of methane and acetaldehyde. In the case of Ni oxide that did not contain in its composition, the selectivity to acetaldehyde values peaked at around 40%. We detected also the formation of small amounts of CO and CO₂ and traces of acetic acid. However, contrary to what was observed for hydrogen, the addition of the mixed oxide Ni affected the formation of CO, CO₂, methane and acetaldehyde. The production of CO, CO₂ and methane increased formation of acetaldehyde decreased with increasing Ni content. These results showed that the presence of Ni favors the breaking of the CC bond, generating CO, CO₂ and methane. Importantly, it was not made the evaluation of stability of these materials in the reaction.

For Ni—Al mixed oxides [V. Mas G. Baronetti, N. Amadeo, M. Laborde, Chem. Mr. J. 138 (2008) 602; V. Mas M. L. Dieuzide, M. Jobbágy, G. Baronetti, N. Amadeo, M. Laborde, Catal. Today 133 (2008) 319], the reaction of steam reforming of ethanol was carried out at higher temperatures (between 823 and 923 K), using different reasons H₂O/ethanol (3.5 to 10.0) and several days of resistance (1.2×10⁻⁴-6, 2×10⁻⁴ g min/mol). For the reason H₂O/ethanol=5.5, ethanol conversion and hydrogen yield increased with increasing temperature and residence time. At temperatures above 873 K and residence times of more than 1.5×10⁻⁵ g min/mL, the values of ethanol conversion and hydrogen yield were 100 and 5.0% respectively. We detected also the formation of CO and CO₂ in all conditions studied. In addition, we observed only traces of methane and the formation of acetaldehyde and ethylene was not detected. At 873 K, when the amount of water in the feed stream was increased, the conversion of ethanol reached a maximum value (100%) for reason H₂O/ethanol equal to 5.5. As the main objective of this study was to evaluate the kinetics reaction, was not made a study of the behavior of these oxides with reaction time, it is not possible to assess the stability of these materials.

Urusaki et al. [K. Urasaki, K Tokunaga, Y. Sekine, M. Matsukata, E. Kikuchi, Catal. Commun. 9 (2008) 600] studied the performance of mixed oxides with perovskite structure (LaAlO₃, SrTiO₃ and BaTiO₃) in the reaction of steam reforming of ethanol at 823 K, using a ratio equal to 10.0 H₂O/ethanol. Conversion values of ethanol were very low (<10%) and the main product was ethylene for all materials studied.

According to the results found in the literature, one can conclude that it is still necessary to develop a catalyst that, besides showing good activity and stability in the reforming reactions of alcohols or a mixture of alcohols at low temperature, is capable of minimize the formation of byproducts such as acetone, acetaldehyde and ethylene.

The catalysts described in this invention meet most needs mentioned above, showing, besides good activity and stability, high selectivity for hydrogen, small amounts of CO and methane and no formation of acetone and ethylene.

### SUMMARY OF THE INVENTION

The hydrogen generated in the method of the invention can be used, among other applications, a fuel cell as the low temperature PEM.

It is an object of the present invention provide a method of producing hydrogen from used catalysts perovskite-type mixed oxides for steam reforming of alcohols at low temperature or a mixture of alcohols with high catalytic activity, high stability and high selectivity for hydrogen.

It is another object of the invention provide a method of producing hydrogen that employs mixed oxide catalysts of the type perovskite to reform the low temperature oxidation of alcohols or a mixture of alcohols with high catalytic activity, high stability and high selectivity for hydrogen.

It is an object of the present invention, to develop catalysts for steam reforming and oxidative reforming of alcohols or a mixture of alcohols, such as bio-ethanol for hydrogen production in the reaction product is exempt from the training acetone and ethylene as reaction by-products

It is still another object of the invention to apply a catalyst-based mixed oxides with perovskite structure of formula La1-xMxNiO3 where x=0.0 to 1.0 and M=elements of the group of alkaline earth metals or elements of the group of lanthanides for hydrogen production.

These and other objectives will become apparent throughout the detailed description of the invention.

### BRIEF DESCRIPTION OF FIGURES

FIG. 1 shows the conversion of ethanol (Xethanol) and product distribution as a function of reaction time LaNiO3 obtained for the catalyst in steam reforming of ethanol. Reaction conditions: Treação=773 K; H2O/ethanol molar ratio=10.0; m_{catalisador}=20 mg; W/Q=0.02 gs/cm³.

FIG. 2 shows the conversion of ethanol (Xₑₜₕₐₙₒₗ) and product distribution as a function of reaction time LaNiO₃ obtained for the catalyst in steam reforming of ethanol. Reaction conditions: T_{rea↑5ão}=1058 K; H₂O/ethanol molar ratio=3.0; m_{catalisador}=20 mg; W/Q=0.02 gs/cm³.

FIG. 3 shows the conversion of ethanol (Xₑₜₕₐₙₒₗ) and product distribution as a function of reaction time obtained for the catalyst LaNiO₃ oxidative reforming of ethanol. Reaction conditions: T_{reação}=1058 K, molar ratio ethanol: H20:02:N2=1,0:3,0:0,5:17,0, mass of catalyst=20 mg; W/Q=0.02 gs/cm³.

### DETAILED DESCRIPTION OF THE INVENTION

The present invention comprises the use of catalysts based mixed oxide containing at least lanthanum, nickel and oxygen in the reactions of steam reforming and oxidative reforming of alcohols at low temperature or a mixture of alcohols, such as bio-ethanol. The catalysts have a perovskite structure represented by:

La₁₋ₓMₓNiO₃

where x=0.0 to 1.0 and M=elements of the group of alkaline earth metals or lanthanides.

Is defined as low-temperature values of temperature between 723 and 823 K. The alcohols used in the invention are alcohols C1-5, such as methanol, ethanol, I-propanol, I-butanol, I-pentanol, or a mixture of alcohols, such as bio-ethanol. Preferably the steam reforming and oxidative reforming of methanol is desired, more preferably ethanol.

The catalyst mixed oxide La₁₋ₓMₓNiO₃ was prepared from three different methods.

Precipitation Method: first, there was a mixture of aqueous solutions containing nickel nitrate, lanthanum nitrate and nitrate of the group of alkaline earth metals or lanthanides where 0.0<x<1.0 preferably 0.0<x<0.7. this mixture was then rapidly added to a solution of sodium excess carbon under vigorous stirring. The pH was kept constant between 7.0 and 10.0, preferably between 7.0 and 9.0. After precipitation, the material was subjected to washing by vacuum filtration with 0.5 to 3 l, preferably 1.5 to 2.5 L of deionized water and then with 0.3 to 1.0 L , preferably with 0.4 to 0.6 L of ethyl alcohol. The precipitate was then dried at 313-423 K, preferably between 323 and 343 K and was kept at this temperature for 12-36 hours, preferably between 18-24 hours. then the material was calcined under a flow of synthetic air at 700-923 K and preferably between 773 and 873 K for 1-5 hours, preferably for 2-4 hours, using a heating rate lower than 20 K/min, preferably less than 15 K/min. The material was then subjected to a second stage of the calcnação 973-1273 K under a flow of synthetic air, preferably between 923 and 1223 K for 8-24 hours, preferably for 9-12 hours, using a heating rate lower than 20 K/min, preferably less than 12 K/min.

Citrate method: A mixture of aqueous solutions containing notrato nickel, lanthanum nitrate and nitrate elements of the group of alkaline earth metals or lanthanides where 0.0<x<1.0, preferably between 328 and 338 K. then acid and ethylene glycol pray ncitrico added to this mixture while maintaining the stirring and heating. The resulting solution was kept in a sand bath to 323-473 K, preferably at 373-393 K for 24-72 hours, preferably between 36-60 hours. Then the material was calcined, using the same calcination conditions used in the precipitation method described previously.

Citrate method with successive additions: first, citric acid was added to an aqueous solution of nickel nitrate. The resulting solution was then kept under constant stirring for 1-2 hours, preferably 1 hour at 298-343 K, preferably between 328 and 338 K. After this period, was added to the etilenaglicol, nitrate and lanthanum nitrate elements of the group of alkaline earth metals or lanthanides where 0.0<x<1.0, preferably 0.0<x<0.7. The obtained mixture remained under constant stirring for 1-2 hours, preferably 1 hour at 298-343 K, preferably between 328 and 338 K. remaining solution was kept on a sand bath to 323-473 K, preferably at 373-393 K for 24-72 hours, preferably between 36-60 hours. then the material was calcined, using the same calcination conditions used in the precipitation method described previously.

The catalysts obtained by the methods described above were, then, uses the reaction of steam reforming and oxidative reforming of alcohols (C₁ to C₅), in particular ethanol, or a mixture of alcohols, such as bio-ethanol. The catalytic tests were performed in a fixed bed reactor at atmospheric pressure for 4 to 72 hours, preferably 60 to 60 hours.

The steam reforming of ethanol, the catalysts were previously reduced under H₂ at 873-1073 K, preferably between 923 and 1023 K for about 2 hours, preferably the reaction temperature is 773 K. The feed stream contained a molar ratio H₂O/alcohol between 0 and 15, preferably between 2 and 10. The residence time (W/H: W=mass of catalyst and Q=volumetric flow rate of regents) also utilize the reaction was 0.01 to 0.2 gs/cm³, preferably between 0.015 and 0.15 gs/cm³.

In the oxidative reform of ethanol, the catalysts were previously reduced in H₂ at 873-1073 K, preferably between 923 and 1023 K for about 2 hours, preferably for 1 hour. The reaction temperature was maintained between 723-823 K, preferably at a temperature of 773 K. relapse and The current alimentation of H2O/alcohol contained a molar ratio between 0 and 15, preferably between 2 and 10. Oxygen was introduced into the feed stream in quantities necessaries O₂/alcohol reason to stay between 0.1 and 5.0, preferably between 0.5 and 1.0. The residence time (W/Q, W=weight of catalyst and flow rate Q+reagent) also utilize the reaction was 0.01 to 0.2 gs/cm³, preferably between 0.015 and 0.15 gs/cm³.

All catalysts tested showed good activity and high selectivity for hydrogen under the conditions described above. The following examples illustrate the invention but are by no means limiting the scope of protection.

### EXAMPLE 1

### Preparation of the Catalyst LaNiO₃ Using the Precipitation Method

To prepare the mixed oxide LaNiO₃ was made, initially, a mixture of lanthanum nitrate solutions containing a ratio La/Ni=1. this mixture was then rapidly added to a solution of 0.5 M sodium carbonate under vigorous stirring, maintaining the pH of the reaction around 8.0.

After precipitation, the material was subjected to washing by vacuum filtration with 2.0 L of deionized water and then with 0.5 L of ethyl alcohol. The precipitate was then dried at 333 K for 20 hours. then the material was calcined in two steps under a flow of synthetic air using a heating rate of 10 K/min in both steps. The first stage was carried out at 823 K for 3 hours. In the second step, the material was calcined at a higher temperature (1173 K) for 10 hours.

### EXAMPLE 2

### Evaluation of the LaNiO₃ Catalyst in Steam Reforming of Ethanol at 773 K, Using a Molar Ratio of Ethanol: H₂O:N2=1,0:10,0:9,0, Mass of Catalyst=20 mg and W/Q=0.02 gs/cm³

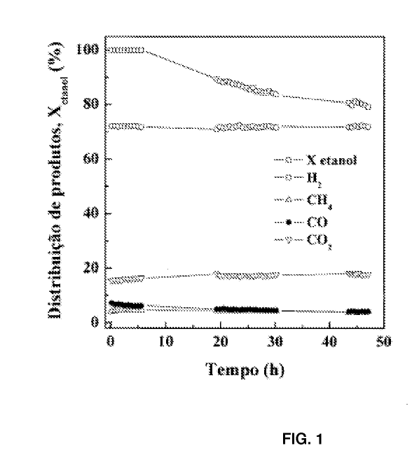

The stability of the catalyst LaNiO₃ prepared according to the methodology described in Example 1 was evaluated in the steam reforming of ethanol for approximately 50 hours of reaction. The catalytic test was performed in a fixed bed reactor at atmospheric pressure under the conditions described above. Before the reaction, the catalyst was reduced under H2 at 973 K for 1 hour. FIG. 1 represents the conversion of ethanol (Xₑₜₕₐₙₒₗ) and product distribution as a function of reaction time obtained for the catalyst LaNiO₃. The initial conversion of ethanol was complete and remained constant during the first 6 hours of reaction. After this period, the catalyst showed a deactivation, stabilizing at a high conversion value (˜80%). The main product was the abtido H₂ (˜72%). were observed also the formation of small amounts of CO₂, CO and methane. In addition, we detected only traces of acetaldehyde and did not observe the production of acetone and ethylene. The product distribution has not changed significantly during the 50 hours of reaction.

### EXAMPLE 3

### Evaluation of Catalyst Performance in LaNiO₃ Steam Reforming of Ethanol at 1058 K, Using a Molar Ratio of Ethanol: H₂O:N₂=1,0:3,0:17,0, Castile Mass=20 mg and W/Q=0.02 gs/cm3

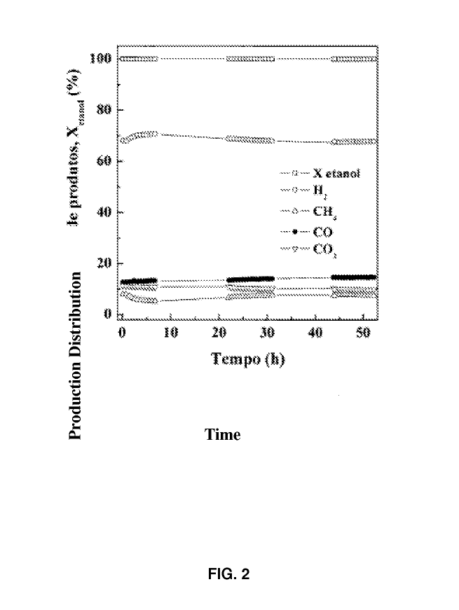

The stability of Castile LaNiO₃, prepared according to the methodology described in Example 1 was evaluated in the steam reforming of ethanol for approximately 50 hours of reaction. The catalytic test was performed in a fixed bed reactor at atmospheric pressure under the conditions described above. Before the reaction, the catalyst was reduced under H2 at 973 K for 1 hour. FIG. 2 shows the convention of ethanol (Xₑₜₕₐₙₒₗ) and product distribution as a function of reaction time obtained for the catalyst LaNiO₃. The initial conversion of ethanol was complete and remained constant during 50 hours of reaction. The main product was the H₂ (˜71%). It was also observed the formation of small amounts of CO, CO₂ and methane was not detected and the production of acetaldehyde, acetone, and carotene. The product distribution has not changed significantly during the 50 hours of reaction.

### EXAMPLE 4

### Evaluation of Catalyst Performance LaNiO₃ Oxidative Reforming of Ethanol at 773 K, Using a Molar Ratio of Ethanol: H₂O:O₂:N=1,0:3,0:0,5:17,0, Mass Catalyst=20 mg and W/Q=0.02 gs/cm³

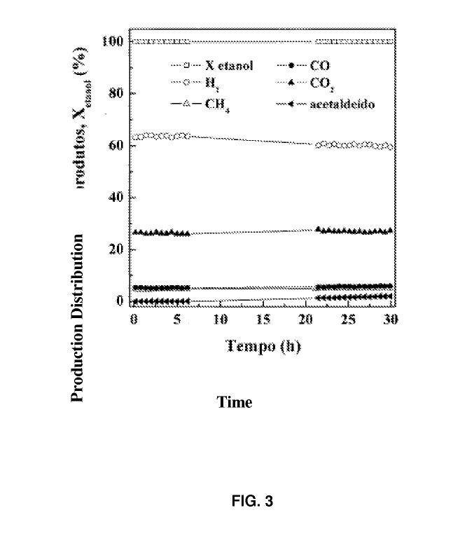

The stability of the catalyst LaNiO₃ prepared according to the methodology described in Example 1 and evaluated in oxidative reforming of ethanol for approximately 30 hours of reaction. The catalytic test was performed in a fixed bed reactor at atmospheric pressure under the conditions described above. Before the reaction, the catalyst was reduced under H2 at 973 K for 1 hour. FIG. 3 shows the conversion of ethanol (Xₑₜₕₐₙₒₗ) and product distribution as a function of reaction time obtained for the catalyst LaNiO₃. The initial conversion of ethanol was complete and remained constant during 30 hours of reaction. The H₂ (˜60%) and CO₂ (˜27%) were the main products detected. small amounts of CO and methane and traces of acetaldehyde were also observed. We did not detect the production of acetone and ethylene. The product distribution has not changed significantly during the 30 hours of reaction.

It is therefore demonstrated that the catalysts described in this invention exhibit good activity and stability, high selectivity for production of hydrogen with small amounts of CO and methane, traces of acetaldehyde and the nunhuma formation of acetone and ethylene at different reaction conditions.

1. A method for hydrogen production, charactcrizcd by comprising:
converting of an alcohol to hydrogen by steam reforming in a fixed bed reactor at atmospheric pressure for 4 to 72 hours at a temperature from 723 to 823 K, uses a catalyst to based oxides with perovskite structures represented by a La₁₋ₓMₓNIO₃ where x=0.0 to 1.0 and M=elements of the group of alkaline earth metals or elements of the lanthanide group.

2. The method for producing hydrogen according to claim 1, wherein the alcohol used is selected from C₁₋₅ alcohols such as methanol, ethanol, I-propanol, iso-propanol, I-butanol, I-pentanol, or a mixture of alcohols such as ethanol.

3. The method for hydrogen production according to claim 2, wherein the fact that alcohol is methanol.

4. The method for the production of hydrogen according to claim 2, wherein the alcohol is ethanol.

5. The method for producing hydrogen according to claim 1, wherein the reaction time is 6 to 60 hours.

6. The method for producing hydrogen according to claim 1, wherein the reaction temperature is 773 K.

7. The method for producing hydrogen according to claim 1, wherein the molar ratio H₂O/alcohol is between 0 to 15.

8. The method for the production of hydrogen according to claim 7, wherein the molar ratio H₂O/alcohol be between 2 and 10.

9. The method for hydrogen production according to claim 1, wherein the residence time W/Q, where W is the mass of catalyst and Q the volumetric flow rate of reactants, uses is 0.01 0, 2 gs/cm³.

10. The method for hydrogen production according to claim 9, wherein the the residence time W/Q is utilized is 0.015 and 0.15 gs/cm³.

11. The method for hydrogen production according to claim 1, wherein the prior to the reaction the catalysts are reduced under H₂ at temperatures from 873 to 1073 K for 2 hours.

12. The method for the production of hydrogen according to claim 11, wherein the fact that prior to the reaction the catalysts are reduced under H2 at temperatures from 923 to 1023 K for 1 hour.

13. The method for producing hydrogen, wherein the conversion to hydrogen via an alcohol reform in the presence of air in a fixed bed reactor at atmospheric pressure for 4 to 72 hours at a temperature from 723 to 823 K, also utilize a catalyst based on oxides with perovskite structures represented by La₁₋ₓMₓNiO₃ where x=0.0 to 1.0 and M=elements of the group of alkaline earth metals or elements of the lanthanide group.

14. The method for producing hydrogen according to claim 13, wherein the alcohol used is selected from alcohols C₁₋₅, such as methanol, ethanol, I-propanol, iso-propranol, I-butanol, I-pentanol, or a mixture of alcohols such as ethanol.

15. The method for hydrogen production according to claim 14, wherein the alcohol is methanol.

16. The method for producing hydrogen according to claim 14, wherein the alcohol is ethanol.

17. The method for producing hydrogen according to claim 13, wherein the reaction time is 6 to 60 hours.

18. The method for the production of hydrogen according to claim 13, wherein the reaction temperature is 773 K.

19. The method for producing hydrogen according to claim 13 wherein the fact that the reason O₂/alcohol is in the range 0.1 to 5.0; H₂O/alcohol and the molar ratio is between 0 to 15.

20. The method for producing hydrogen according to claim 29, wherein the reason O₂/alcohol is between 0.5 and 1.0, and H₂O/alcohol molar ratio is between 2 and 10.

21. The method for the production of hydrogen according to claim 13, wherein the residence time W/Q utilized is 0.01 to 0.2 gs/cm³.

22. The method for the production of hydrogen according to claim 13, wherein the residence time W/Q is utilized is 0.015 and 0.15 gs/cm³.

23. The method of production of hydrogen according to claim 13, wherein the prior to the reaction catalysts are reduced under H2 at temperatures from 873 to 1073 K for 2 hours.

24. The method of production of hydrogen according to claim 13, wherein the fact that prior to the reaction catalysts are reduced under H2 at temperatures from 923 to 1023 K for 1 hour.

25. An application of a catalyst based on oxides with perovskite structures for hydrogen production by claim 13 and wherein said catalyst being represented by La₁₋ₓMₓNiO₃ where x=0.0 to 1.0 and M=elements of the group of alkaline earth metals or elements of the lanthanide group and be used in steam reforming and oxidation of alcohols (C₁ to C₅) or a mixture of these alcohols.
